(19) United States
(12) Patent Application Publication
(10) Pub. No.: US 2022/0389296 A1
(43) Pub. Date: Dec. 8, 2022

(54) ADHESIVE ANTI-SLIP PAD

(71) Applicant: Chadwick James Bender, Olathe, KS (US)

(72) Inventor: Chadwick James Bender, Olathe, KS (US)

(21) Appl. No.: 17/341,984

(22) Filed: Jun. 8, 2021

(51) Int. Cl. C09K 3/14; A63F 13/24

(52) U.S. Cl. CPC C09K 3/149; A63F 13/24; C09J 9/00

(57) ABSTRACT

An adhesive anti-slip pad for placement on the finger, thumb, or palm of a wearer. The adhesive anti-slip includes a first side having a first surface comprising a textured material and a second side having a second surface comprising an adhesive. The adhesive anti-slip pad is configured to be placed on a thumb, finger, or a palm of the wearer. The adhesive anti-slip pad further comprises a thickness so that if the adhesive anti-slip pad contacts the surface of another object after placement of the adhesive anti-slip pad on the thumb, finger, or palm, the wearer receives a tactile response.

### TECHNICAL FIELD

Embodiments of the present invention relate to adhesive anti-slip pads configured for placement on the thumb, finger, and/or palm of a wearer for use in gaming.

Traditionally, success in video gaming is largely connected to the ability to make precise physical actions on a video game controller, or alternatively, a keyboard and mouse. Timing, direction, and pressure are all relevant in achieving the desired results. This is particularly prevalent in competitive gaming, in which complex, time-dependent combinations of button and thumbstick commands are critical for success. Any slippage or loss of contact with the thumbstick and/or buttons of the controller can lead to undesirable actions and unintended results. For example, during longer and/or more stressful gaming sessions, sweat can accumulate on the thumb and fingers of the player, increasing the chance for incidental slippage with the controller. Additionally, over time and through extensive use, controller thumbsticks can wear down, leading to smooth surfaces and reduction of the textured aids on the thumbsticks.

Previous attempts at improving the gaming experience through gripping aids are associated with inherent flaws. For example, in one such attempt, grips have been manufactured as slips or covers that are placed over the top of the controller thumbsticks. However, such slips or covers rely on a piece of material, stretching and fitting over the top of the thumbstick. Such covers or slips are prone to coming loose and sliding to non-optimal positions and can even slide completely off the thumbstick. Such issues can hinder performance while using the controller, and over time, the embossments, ridges, or other gripping aids on the cover or slips will wear down, requiring replacement of the cover or slip. Furthermore, because they attach to the control sticks, such covers or slips do not address the underlying problem of slippage due to sweat accumulation between the thumbs or fingers and the cover or slip attached to the thumbstick.

Other attempts have been made to apply a gripping effect to a user, instead of to a controller. For example, some commercial products have been manufactured that as gels or other similarly viscous liquids that act as a gripping agent when applied to the hand of a user. However, such products must be continuously applied during long gaming sessions or tournaments and have the potential for accumulation over time, making buttons and controllers sticky and potentially interfering with the free operation on the controls. Accordingly, a need exists for gripping aids that can be applied to a user (or a controller) and which are not prone to sliding out of place, wearing down, and do not require continuous re-application during a gaming session.

### SUMMARY

A first embodiment of the present invention is directed to an adhesive anti-slip pad, the adhesive anti-slip pad comprising: a first side having a first surface comprising a non-slip texture; and a second side having a second surface comprising an adhesive, wherein the adhesive anti-slip pad is of a dimension that that is configured for placement of the adhesive anti-slip pad on a thumb, finger, or palm of a wearer, or any combination thereof, and wherein the non-slip surface provides a gripping or non-slipping effect between the adhesive anti-slip pad and a surface of an object when the adhesive anti-slip pad is in contact with the surface of the object.

Another embodiment of the present invention is directed to an adhesive anti-slip pad, the adhesive anti-slip pad comprising: a sheet of material comprising: a first side having a first surface comprising a textured rubber polymer; and a second side having a second surface comprising an adhesive, wherein the sheet of material is die cut into an adhesive anti-slip pad in a predetermined shape, and wherein the textured rubber polymer provides a gripping or nonslip effect when in contact with a surface of an object.

Another embodiment of the present invention is directed to an adhesive anti-slip pad comprising: a first side having a first surface comprising a textured material; and a second side having a second surface comprising an adhesive, wherein the disposable adhesive anti-slip pad is configured to be placed on a thumb, a finger, or a palm of a wearer, and wherein the disposable adhesive anti-slip pad comprises a thickness so that if the disposable adhesive anti-slip pad comes into contact with a surface of another object after placement of the disposable adhesive anti-slip pad on the thumb, finger, or palm, the wearer receives a tactile response.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1A is a top perspective view of a first surface of an adhesive anti-slip pad comprising a textured or otherwise non-slip material layer in accordance with some embodiments of the invention;

FIG. 1B is a bottom perspective view of a second surface of an adhesive anti-slip pad comprising an adhesive applied to the second surface in accordance with some embodiments of the invention;

FIG. 1C is a cross-section view of an adhesive anti-slip pad in accordance with some embodiments of the invention;

FIG. 1D is a cross-section view of an adhesive anti-slip pad with a release film in accordance with some embodiments of the invention;

FIG. 2 is a top perspective view of the hand of a wearer illustrating exemplary placements of the adhesive anti-slip pad in accordance with exemplary embodiments of the invention; and

FIG. 3 is a top perspective view of the hand of a wearer illustrating exemplary placements of the adhesive anti-slip pad in accordance with exemplary embodiments of the invention; and

FIGS. 4A-E illustrates exemplary shapes and designs of adhesive anti-slip pad in accordance with exemplary embodiments of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Broadly, embodiments of the present invention are directed to adhesively applied, anti-slip pads that may be placed and secured on the finger, thumb, and/or palm of a wearer for improving the gripping action between the wearer and another object. In some embodiments, the gripping action may be created through a textured surface of the adhesive anti-slip pad. By way of non-limiting example, in some embodiments, after placement of the adhesive anti-slip pads on the finger, thumb, and/or palm of the wearer, a gripping action from the adhesive anti-slip pad may be applied to a video game controller, joystick, or keyboard and mouse for gaming. The gripping action from the adhesive anti-slip pad aids in maintaining contact and grip between the wearer's finger, thumb, and/or palm with the controller, joystick, or keyboard and mouse, as well as preventing unintentional slipping of the finger, thumb, and/or palm.

It will be appreciated that while references herein may be made to video game controllers, joysticks, buttons, keyboard and mouse, and other gaming accessories and peripherals, the present invention may be used in a variety of settings and applications that are not necessarily related or directed to video games. For example, the present invention may be applicable and used in any circumstances in which it would be advantageous to employ a gripping effect between the wearer of the adhesive anti-slip pad and an object. For example, such circumstances may include but are not limited to, the handling of power or mechanical tools, construction, moving objects, or other applications in which a gripping or non-slip aid would be beneficial.

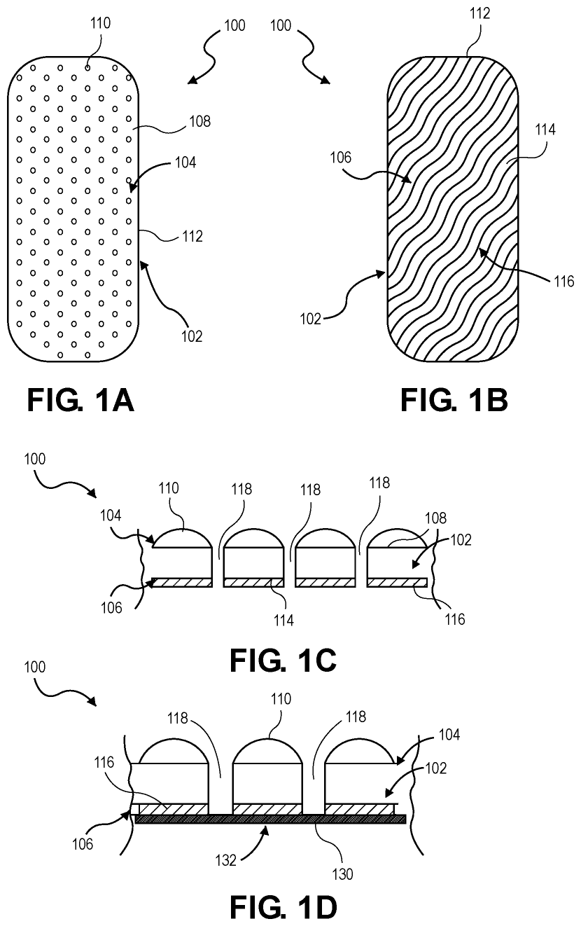

Turning now to the figures, FIGS. 1A-1D depict an exemplary embodiment of adhesive anti-slip pad, referred to generally by reference numeral 100. As generally depicted in FIGS. 1A-1D, and in some embodiments, adhesive anti-slip pad 100 may comprise a textured or otherwise non-slip material layer 102. In some embodiments, textured or otherwise non-slip material layer 102 comprises a first side 104 and a second side 106. In some embodiments, textured or otherwise non-slip material layer 102 may be constructed from a rubber polymer material. Alternatively, in further embodiments, textured or otherwise non-slip material layer 102 may be constructed or made from other known or yet to be discovered non-slip or gripping material, including but not limited to neoprene, ethylene propylene diene monomer rubber (EPDM rubber), polyvinyl chloride (PVC) foam, polyethylene, sponge rubber, silicone foam, urethane, cork, rubber, acrylic, polyester or styrene-butadiene rubber (SBR). For brevity, the term “textured material layer” is employed herein, although a POSITA, having reviewed this disclosure will appreciate that the non-slip effect may be achieved directly through the use of a non-slip material rather than via a texture applied to the material. In some embodiments, textured material layer 102 may comprise a single piece of material. In further embodiments, textured material layer 102 may comprise two or more distinct pieces of material. In embodiments in which textured material layer 102 comprises two or more distinct pieces of material, the two or more distinct pieces of material may be formed together through heat sealing bonding methods, adhesive methods, or other methods known in the art.

In some embodiments, adhesive anti-slip pad 100 may be placed on multiple positions on the finger, thumb, and/or palm of a wearer. Accordingly, in some embodiments, textured material layer 102 may be made from a flexible material that is able to contour to the shape of the wearer's finger, thumb, and/or palm. In some embodiments, textured material layer 102 may be made from a material suitable for imprinting, forming, or otherwise displaying images, markings, or patterns. For example, in some embodiments, logos or other brandings, markings, or illustrations may be imprinted or formed on textured material layer 102.

Turning now to FIG. 1A, a top side view of an exemplary embodiment of first side 104 of textured material layer 102 is illustrated. As illustrated, in some embodiments textured first side 104 may comprise a first surface 108, generally corresponding to the top portion of first side 104. As further illustrated in FIG. 1A, in some embodiments, first surface 108 may comprise a plurality of grip aids 110, for providing a gripping action between adhesive anti-slip pad 100 and another object. In some embodiments, grip aids 110 may be selectively applied to, and cover a pre-determined percentage of first surface 108. For example, in some embodiments, grip aids 110 may be applied to first surface 108 and cover at least 20%, at least 50%, at least 75%, at least 90%, or greater than or equal to 90% of first surface 108. In some embodiments, grip aids 110 may be selectively placed on first surface 108 to provide for selective areas that provide a gripping effect. For example, in some embodiments, it may be advantageous for selected areas on first surface 108 to be free of grip aids 110. In some embodiments, grip aids 110 may be made from the same material as textured material layer 102. Alternatively, in further embodiments, grip aids 110 may be constructed from a different material than textured material layer 102, including but not limited to neoprene, EPDM rubber, PVC foam, polyethylene, sponge rubber, silicone foam, urethane, cork, rubber, acrylic, polyester or SBR.

In some embodiments, grip aids 110 may be molded, formed, manufactured or otherwise placed on first surface 108 during manufacturing or construction of textured material layer 102. In further embodiments, grip aids 110 may alternatively be added, formed, or otherwise placed on first surface 108 after manufacturing or construction of textured material layer 102. In some embodiments, grip aids 110 may be permanently affixed, molded, or otherwise placed on first surface 108 of textured material layer 102. Alternatively, in further embodiments, grip aids 110 may be removably attachable to first surface 108 of textured material layer 102. In some embodiments, grip aids 110 may be removably attached to first surface 108 using any known method of removable attachment, including but not limited to adhesives, mechanical fasteners, or other methods of removable attachment.

In some embodiments, grip aids 110 may be designed as a plurality of ribs, protrusions, indentations, or other textured components for engaging the surface of an object and for providing an anti-slip or gripping effect between adhesive anti-slip pad 100 and the object. In some embodiments, grip aids 110 may be configured to increase tactile engagement between adhesive anti-slip pad 100 and the object when the object is gripped from virtually any direction. Accordingly, in some embodiments, grip aids 110 may be defined or formed by a multidirectional surface pattern of ribs, protrusions, indentations, or other textured components, including but not limited to a regular or irregular pattern of protrusions defining peaks and valleys.

In some exemplary embodiments, adhesive anti-slip pad 100 may optionally or additionally comprise an extending member or portion (not shown) for engaging the thumbstick of a video game controller. For example, in some embodiments, an extending member may extend from first surface 108 to engage with a video game controller. In some embodiments, the extending member may be configured to act as a ball and socket type apparatus, and by removing the top thumb pad portion of the controller thumbstick, the extending member may engage with the controller thumbstick. In some embodiments, the extending member may be constructed from a generally solid piece of material, that is able to engage with a video game controller thumbstick or other object while still retaining its shape. For example, in some embodiments the extending member may be constructed from aluminum, plastic, or solid materials.

In some embodiments, the dimensions, size, and/or geometric shape of textured material layer 102 may vary, and further, may be based at least in part on the placement location of adhesive anti-slip pad 100 and/or the intended application of adhesive anti-slip pad 100. For example, in some embodiments, textured material layer 102 may generally comprise a circular, elliptical, ovular, triangular, rectangular, square, pentagonal, or other polygonal geometric shapes. Additionally, in further embodiments, textured material layer 102 may comprise an asymmetric geometric shape, such as, for example, an oblong design or one or more sides comprising a concave or convex design. For example, in some embodiments, it may be advantageous for adhesive anti-slip pad 100 to comprise at least one side having a concave shape to allow for a quick transition between adhesive anti-slip pad 100 and the skin of the wearer.

Furthermore, in some embodiments, the thickness of textured material layer 102 may vary. For example, in some embodiments, textured material layer 102 may comprise a thickness that is no greater than the maximum thickness that provides for a tactile response between a wearer and the object in contact with textured material layer 102. By way of non-limiting example, in some applications anti-slip adhesive pad 100 may be applied to the thumb of a wearer for use in video gaming. In such a scenario, it may be advantageous for the wearer to receive a tactile response from the controller, and accordingly, textured material layer 102 may comprise a thickness that allows the wearer to still feel the controller or thumbstick. For example, in some embodiments textured material layer 102 may comprise a thickness of about 0.1 mm (10 μm) to about 1.5 mm (1500 μm). In some embodiments, adhesive anti-slip pad 100 may be used in a variety of applications, and further, may be placed on various positions on a wearer. Accordingly, in some embodiments, textured material layer 102 may comprise varying thicknesses, depending on the intended placement location of adhesive anti-slip pad 100 on the wearer. In some embodiments, textured material layer 102 may comprise a uniform thickness. Alternatively, in further embodiments, textured material layer 102 may comprise non-uniform thickness.

Furthermore, in some embodiments, the dimensions of textured material layer 102 may be based at least in part on the intended placement location of adhesive anti-slip pad 100. For example, in some embodiments, adhesive anti-slip pad 100 may be designed for placement on the thumb, finger, and/or palm of a wearer. Accordingly, textured material layer 102 may have dimensions that can cover at least a portion of the wearer's thumb, finger, or palm. It will be appreciated that in some embodiments, textured material layer 102 may have a dimension that substantially covers the pad of the wearer's thumb or finger and extends further around the wearer's thumb or finger after placement. Alternatively, in further embodiments, textured material layer 102 may have dimensions that covers only a portion of the wearer's thumb, finger, or palm. For example, in some embodiments textured material layer 102 may have a length of approximately 0.5 cm to about 5 cm. In some embodiments, textured material layer 102 may have a height of approximately 0.5 cm to about 5 cm. Described another way, in some embodiments, textured material layer 102 may have a surface area of about 0.25 cm² to about 25 cm².

Furthermore, in some embodiments, adhesive anti-slip pad 100 may be used by wearers of varying sizes, such as for example, both children and adult users. Additionally, it is well known that variances in hand and finger size is present in the population, and accordingly, the dimensions of textured material layer 102 may have varying sizes to account for varying sizes of potential wearers. Accordingly, the dimensions, shape, and/or size of textured material layer 102 may vary depending on the embodiment and may be dependent at least in part on the location of placement of adhesive anti-slip pad 100. By way of non-limiting example, the dimensions of textured material layer 102 that may be placed on the distal phalanx portion of a thumb may have different dimensions that the dimensions of textured material layer 102 that may be placed on the palm.

In some embodiments, textured material layer 102 may be formed or cut from a sheet of textured material (not shown) into pre-determined shapes and dimensions. For example, in some embodiments, the sheet of textured material can be die cut to form the pre-determined shapes and dimensions of textured material layer 102. In some embodiments, the die cutting is accomplished using rotary die cutting equipment which is well-known to those skilled in the art. In further embodiments, it will be appreciated that other known methods of die cutting may also be implemented in forming the shapes and dimensions of textured material layer 102. It will be further appreciated that textured material layer 102 may be cut or formed from the sheet of textured material using methods other than die cutting. After textured material layer 102 has been formed, die cut, or otherwise manufactured, textured material layer 102 may comprise a defined outer perimeter 112, defining the shape and boundaries of textured material layer 102.

FIG. 1B illustrates an exemplary embodiment of a second side 106 of adhesive anti-slip pad 100. In some embodiments, second side 106 may be the bottom portion of textured material layer 102. Alternatively, second side 106 may be the bottom layer of an additional layer (not shown) applied to textured material layer 102. For example, in some embodiments, it may be advantageous for adhesive anti-slip pad 100 to comprise multiple layers, such as for example, multiple textured material layers 102. As depicted in FIG. 1B, in some embodiments, second side 106 may comprise a second surface 114. In some embodiments, second surface 114 may be a receiving surface for an adhesive or other bonding material. For example, in some embodiments, adhesive 116 may be applied to second surface 114. In some embodiments, adhesive 116 may be applied as an adhesive layer, substantially covering the entirety of second surface 114. In some embodiments, adhesive 116 may be selectively applied to second surface 114, covering a pre-determined percentage of second surface 114, and for example, may cover at least 20%, at least 50%, at least 75%, at least 90%, or greater than or equal to 90% of second surface 114.

In some embodiments, adhesive 116 may be any known adhesive material, including for example, pressure sensitive adhesives that are generally known and used for wound bandages or other adhesives that are known and used for contact with human skin. In some embodiments, adhesive 116 may comprise a single adhesive composition. Alternatively, in further embodiments, adhesive 116 may comprise a blend or mixture of one or more different types of adhesive compositions. In some embodiments, adhesive 116 may be an adhesive that is reasonably skin compatible and/or hypoallergenic. For example, in some embodiments, adhesive 116 may comprise an acrylate, including methacrylate and epoxy diacrylates, or a blend of materials including, but not limited to rubbers, acrylate, vinyl resins, and/or silicone formulations. In some embodiments, adhesive 116 may further comprise waterproof or water-resistant properties. For example, in some embodiments, adhesive 116 may be an adhesive composition comprising inherent waterproof or water-resistant properties. Alternatively, in some embodiments a waterproof or water-resistant material may be applied as a coating to adhesive 116 or may be added in the manufacturing process of making adhesive 116.

In some embodiments, adhesive 116 may be applied to second surface 114 using any known method of applying an adhesive material to the surface of an object, including but not limited to cold seal methods, heat seal methods, or other known or yet to be discovered methods of applying an adhesive to the surface of an object. Adhesive 116 may be applied to second surface 114 at any point during the manufacturing process or formation of textured material layer 102. For example, in some embodiments, adhesive 116 may be applied to second surface 114 when textured material layer 102 has not yet been die cut or formed from a sheet of textured material. Alternatively, in other embodiments, adhesive 116 may be applied to second surface 114 after textured material layer 102 has been die cut or otherwise formed from a sheet of textured material. In some embodiments, the thickness of adhesive 116 may be dependent on the intended use and application of adhesive anti-slip pad 100. For example, in some embodiments, adhesive anti-slip pad 100 may require a thickness that provides for a tactile response to a wearer. Accordingly, in some embodiments the thickness of adhesive 116 should generally comprise a thickness that allows for bonding to the skin of a wearer, but thin enough that adhesive anti-slip pad 100 retains the functionality of providing a tactile response. For example, in some embodiments, the thickness of adhesive 116 as applied to second surface 114 may be about 10 μm to about 50 μm in thickness.

FIGS. 1C-D depict cross-sectional views of an exemplary embodiment of adhesive anti-slip pad 100 that features an anti-slip texture. In some embodiments, adhesive anti-slip pad 100 may optionally or additionally comprise a degree of permeability or semi-permeability, allowing for at least some airflow to pass through adhesive anti-slip pad 100. In some embodiments, the permeability or semi-permeability of adhesive anti-slip pad 100 may be achieved through gaps, spaces, or voids 118 selectively spaced throughout the dimension of adhesive anti-slip pad 100. In some embodiments, voids 118 may extend throughout the entire thickness of textured material layer 102, adhesive 116, or both. In exemplary embodiments comprising additional layers, voids 118 may extend through each of the additional layers as well. In some embodiments, voids 118 may be distributed throughout a pre-determined percentage of textured material layer 102, adhesive 116, or both. In some embodiments, voids 118 may be selectively distributed throughout at least 20%, at least 50%, at least 75%, at least 90%, or greater than or equal to 90% of textured material layer 102 and/or adhesive 116.

In some embodiments, voids 118 may be defined at any point during the manufacturing process. For example, in some embodiments voids 118 may be defined into textured material layer 102, before textured material layer 102 has been die cut or otherwise formed. Alternatively, in some embodiments, voids 118 may be defined into textured material layer 102 after the sheet of textured material has been die cut or otherwise formed. In some embodiments, voids 118 may be defined into textured material layer 102 prior to the application of adhesive 116 on second surface 114. Alternatively, in further embodiments, voids 118 may be defined into textured material layer 102 after application or depositing of adhesive 116 on second surface 114. Accordingly, in some embodiments, voids 118 may be defined through both adhesive 116 and textured material layer 102. In some embodiments, voids 118 may be continuous gaps, holes, or openings defined through adhesive 116 and textured material layer 102, wherein voids 118 comprise a continuous opening through both adhesive 116 and textured material layer 102.

In some embodiments, adhesive anti-slip pad 100 may be positioned on the finger, thumb, and/or palm of a wearer for use to improve the gripping effect and/or to prevent slipping between the wearer and a video game controller or mouse and keyboard. Accordingly, voids 118 may provide for at least some level of permeability between adhesive anti-slip pad 100 and the skin of the wearer, allowing for airflow to help cool the wearer's skin and/or for allowing space for sweat to evaporate. For example, during long gaming sessions sweat or moisture may build up in the wearer's hands, including the palm, fingers, and thumbs. Voids 118 may aid in providing space for moisture or sweat to evaporate, reducing or limiting the chance of adhesive anti-slip pad 100 from prematurely coming off.

FIG. 1D illustrates a cross-sectional view of an exemplary embodiment of adhesive anti-slip pad 100 comprising an optional release film 130. As depicted, in some embodiments, adhesive anti-slip pad 100 may further comprise release film 130, which may be applied to adhesive 116. In some embodiments, release film 130 may be removably attached to adhesive 116, and therefore, removably attached to adhesive anti-slip pad 100. Release film 130 may be used to protect adhesive 116 until adhesive anti-slip pad 100 is ready for placement and use. In some embodiments, release film 130 can substantially cover the entirety of adhesive 116. For example, in some embodiments release film 130 may cover at least 75%, at least 90%, or greater than or equal to 90% of adhesive 116 applied to adhesive anti-slip pad 100. In some embodiments, release film 130 may have larger dimensions than the dimensions of adhesive anti-slip pad 100, and accordingly, in some embodiments at least a portion of release film 130 may overhang beyond outer perimeter 112 of adhesive anti-slip pad 100. In some embodiments, release film 130 may comprise a single piece of material. Alternatively, in some embodiments, release film 130 may comprise two or more pieces of material that may be releasably attached to adhesive 116.

In some embodiments, release film 130 may be constructed from any known or suitable material that can be applied as a removably attachable protection layer for an adhesive. For example, in some embodiments release film 130 may be constructed from a paper liner material that is known in the art such as a Kraft paper. In further embodiments, release film 130 may be constructed from a plastic-based film material that is known in the art, and may, for example, be made from polyethylene, polypropene polyester, or composite mixtures comprising a mixture of any of materials.

In some embodiments, release film 130 may further comprise a release agent 132, to aid in removing release film 130 from adhesive 116 and accordingly, from adhesive anti-slip pad 100. In some embodiments, release agent 132 may be cross-linkable silicone, or other similar materials that have a low surface energy. Accordingly, release agent 132 may aid in facilitating the removal of release film 130 from adhesive 116 without damaging textured material layer 102 or reducing the bond between adhesive 116 and textured material layer 102. For example, in some embodiments, release film 130 may be removably attached to adhesive anti-slip pad 100 via adhesive 116 until just prior to attaching adhesive anti-slip pad 100 to a wearer's thumb, finger, or palm. Release film 130 may be removable by hand, and after removal of release film 130, adhesive anti-slip pad 100 may be secured to a wearer's thumb, finger, or palm.

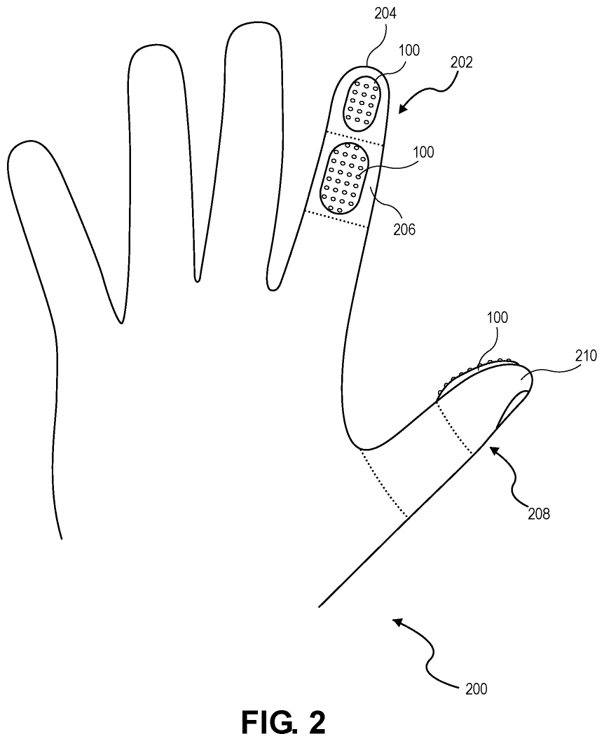

Turning now to FIG. 2, an exemplary right hand of a wearer is depicted and referenced generally by reference numeral 200. FIG. 2 generally illustrates an exemplary embodiment demonstrating an example of placement locations of adhesive anti-slip pad 100 on hand 200. It will be appreciated that hand 200 may be substituted with a left hand of a wearer. Accordingly, in some embodiments, adhesive anti-slip pad 100 may be placed on the left hand and the right hand of the wearer concurrently. As depicted in FIG. 2, in some embodiments adhesive anti-slip pad 100 may be placed on various positions of hand 200. FIG. 2 is intended to be illustrative, depicting exemplary positions of placement of adhesive anti-slip pad 100, and is not intended to be limiting or exhaustive of the positions that adhesive anti-slip pad 100 may be placed.

For example, in some embodiments, adhesive anti-slip pad 100 may be positioned and secured to the index finger 202 of the wearer. In some embodiments, adhesive anti-slip pad 100 may be designed for placement on a distal phalanx 204 of index finger 202. In further embodiments, adhesive anti-slip pad 100 may be additionally or optionally be designed for placement on the intermediate phalanx 206 of index finger 202. As also depicted in FIG. 2, adhesive anti-slip pad 100 may additionally or optionally be designed for placement on the thumb 208. In some embodiments, adhesive anti-slip pad 100 may be designed for placement on the distal phalanx 210 of thumb 208. In some embodiments, and as described above, adhesive anti-slip pad 100 may comprise varying sizes or dimensions depending on the location of placement. For example, in some embodiments, adhesive anti-slip pad 100 may be larger in size and/or dimension for placement on thumb 208 than when designed for placement on index finger 202. Additionally, in some embodiments, adhesive anti-slip pad 100 may have varying sizes and/or dimensions even when placed on the same finger, thumb, or palm. For example, adhesive anti-slip pad 100 may be smaller in size when designed for placement on distal phalanx 204 then when designed for placement on intermediate phalanx 206. Alternatively, in further embodiments, adhesive anti-slip pad 100 may comprise the same size and/or dimension regardless of location of placement on hand 200.

After placement of adhesive anti-slip pad 100 on the one or more locations on hand 200, adhesive anti-slip pad 100 may be used to improve the gripping effect and/or to reduce slipping between hand 200 and another object. By way of non-limiting example, one such object that adhesive anti-slip pad 100 may be used with is a video game controller or a keyboard and mouse (not shown). For example, adhesive anti-slip pad 100 placed on distal phalanx 210 of thumb 208 may be used to engage the thumbstick, directional pad, or buttons of a video game controller, or alternatively, with the keys of a keyboard or the button of a mouse. Additionally, adhesive anti-slip pad 100 placed on distal phalanx 204 of index finger 202 may be used to engage the triggers of a video game controller, or alternatively, engage the keys of a keyboard or a mouse. Furthermore, adhesive anti-slip pad 100 placed on intermediate phalanx 206 of index finger 202 may be used to engage top buttons or “bumpers” located on a video game controller.

In some embodiments, after placement and use, adhesive anti-slip pad 100 may be disposed of after a single use, providing for a single-use, disposable adhesive anti-slip pad 100. Alternatively, in further embodiments, adhesive anti-slip pad 100 may be reusable and used more than once. For example, in some embodiments release film 130 may be re-attached to adhesive anti-slip pad 100 after placement and use to protect adhesive 116 for future applications. Alternatively, in some embodiments a new release film 130 or a different protective cover may be attached to adhesive anti-slip pad 100 after placement and use to protect adhesive 116 for future applications.

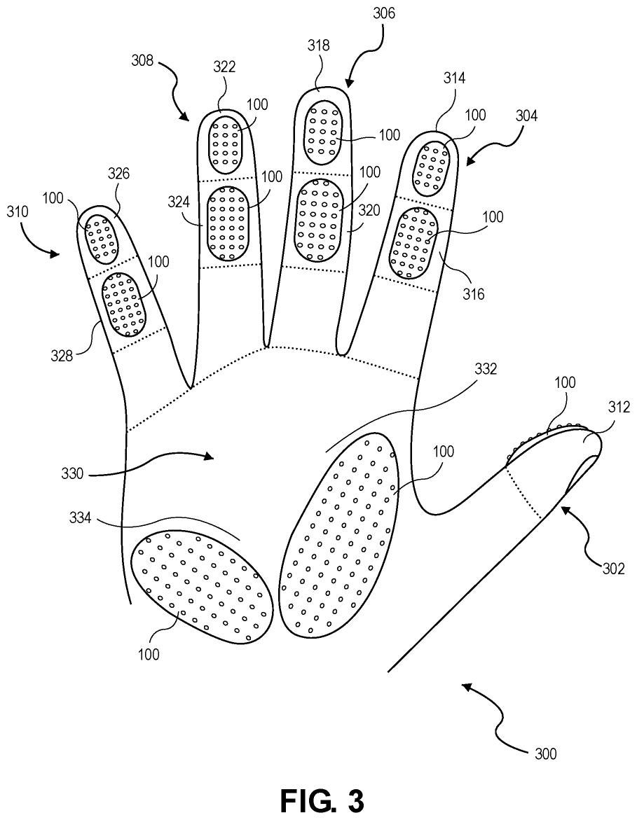

Turning now to FIG. 3, an exemplary hand of a wearer is depicted and referenced generally by reference numeral 300. FIG. 3 illustrates exemplary positions that adhesive anti-slip pad 100 may be placed on hand 300. FIG. 3 illustrates hand 300 as the right hand of a wearer, however, it will be appreciated that hand 300 may be substituted with a left hand of a wearer. The exemplary positions depicted in FIG. 3 is intended to be illustrative, depicting exemplary positions of placement of adhesive anti-slip pad 100, and are not intended to be limiting or exhaustive of the positions that adhesive anti-slip pad 100 may be placed.

FIG. 3 depicts hand 300 comprising a thumb 302, index finger 304, middle finger 306, ring finger 308, and little finger 310. As further illustrated in FIG. 3, thumb 302 comprises a distal phalanx portion 312. In some embodiments, adhesive anti-slip pad 100 may be designed for placement on distal phalanx portion 312 of thumb 302. As further illustrated in FIG. 3, index finger 304 comprises a distal phalanx portion 314 and an intermediate phalanx portion 316. In some embodiments adhesive anti-slip pad 100 may be designed for placement on distal phalanx portion 314 and/or intermediate phalanx portion 316 of index finger 304. As further illustrated in FIG. 3, middle finger 306 comprises a distal phalanx portion 318 and an intermediate phalanx portion 320. In some embodiments, adhesive anti-slip pad 100 may be designed for placement on distal phalanx portion 318 and/or intermediate phalanx portion 320 of middle finger 306. As further illustrated in FIG. 3, ring finger 308 comprises a distal phalanx portion 322 and an intermediate phalanx portion 324. In some embodiments, adhesive anti-slip pad 100 may be designed for placement on distal phalanx portion 322 and/or intermediate phalanx portion 324 of ring finger 308. As further illustrated in FIG. 3, little finger 310 comprises a distal phalanx portion 326 and an intermediate phalanx portion 328. In some embodiments, adhesive anti-slip pad 100 may be designed for placement on distal phalanx portion 326 and/or intermediate phalanx portion 328 of little finger 310. As further depicted in FIG. 3, hand 300 further comprises a palm 330. Palm 330 further comprises a thenar portion 332 and thenar eminence portion 334. In some embodiments, adhesive anti-slip pad 100 may be designed for placement on thenar portion 332 and/or thenar eminence portion 334 of palm 330.

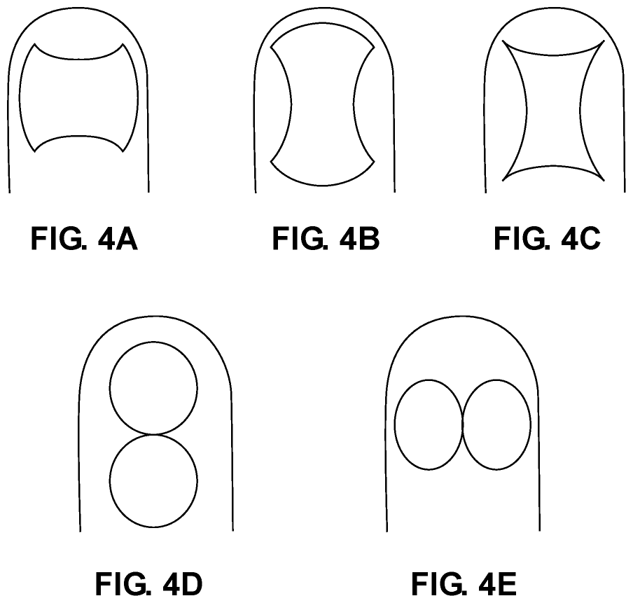

Turning now to FIGS. 4A-E, exemplary embodiments of adhesive anti-slip pad are illustrated, demonstrating non-limiting examples of designs of adhesive anti-slip pad. For example, as illustrated in FIGS. 4A-C, in some embodiments adhesive anti-slip pad may comprise one or more selectively positioned concave positions that may allow for quick transitions between adhesive anti-slip pad 100 and the skin of the wearer with a controller, thumbstick, or other object. FIGS. 4D-E illustrate exemplary embodiments in which two smaller adhesive anti-slip pads 100 can be applied in generally the same area of a wearer for additional control of coverage area. While FIGS. 4A-4E illustrate the shapes of an adhesive anti-slip pad applied to a distal phalanx, these shapes and contours can also be utilized in adhesive anti-slip pads shaped and sized for placement elsewhere as described above with respect to FIG. 3.

In exemplary embodiments, adhesive anti-slip pad 100 may be designed for placement on a video game controller, mouse and keyboard, other gaming accessories, or other surfaces that may benefit from the application of a pad that increases gripping and/or non-slip properties. For example, in some embodiments, adhesive anti-slip pad 100 may be die cut or formed having dimensions for placement on the top portion of the thumbsticks of a video game controller. In further embodiments, adhesive anti-slip pad 100 may be die cut or formed having dimensions for placement on a button, tab, and/or trigger of a video game controller. In even further embodiments, adhesive anti-slip pad 100 may be die cut or formed having dimensions for placement on the top portion of the keys of a keyboard. In even further embodiments, adhesive anti-slip pad 100 may be die cut or formed having dimensions to placement on either of the right or left button of a mouse. These examples are intended to be illustrative and are not intended to be limiting as to the applications of adhesive anti-slip pad 100.

Although the invention has been described with reference to the embodiments illustrated in the attached drawing figures, it is noted that equivalents may be employed, and substitutions made herein without departing from the scope of the invention as recited in the claims.

Having thus described various embodiments of the invention, what is claimed as new and desired to be protected by Letters Patent includes the following:

1. An adhesive anti-slip pad, the adhesive anti-slip pad comprising:
a first side having a first surface comprising a non-slip texture;
a second side having a second surface comprising an adhesive, and
wherein the adhesive anti-slip pad comprises a dimension that is configured for placement of the adhesive anti-slip pad on a thumb, finger, or palm of a wearer, and
wherein the non-slip texture provides a gripping or non-slipping effect between the adhesive anti-slip pad and a surface of an object when the adhesive anti-slip pad is in contact with the surface of the object.

2. The adhesive anti-slip pad of claim 1, wherein the adhesive anti-slip pad is made from a flexible material.

3. The adhesive anti-slip pad of claim 2, wherein the adhesive anti-slip pad is configured to contour to a shape of a wearer's thumb, finger, or palm.

4. The adhesive anti-slip pad of claim 3, wherein the adhesive anti-slip pad is configured to be disposed of after a first application to a wearer's thumb, finger, or palm.

5. The adhesive anti-slip pad of claim 1, wherein the adhesive anti-slip pad is at least semi-permeable.

6. The adhesive anti-slip pad of claim 1, wherein the non-slip texture is made from a rubber polymer material.

7. The adhesive anti-slip pad of claim 6, wherein the non-slip texture is a textured surface comprising a plurality of ribs, protrusions, or indentations, or any combination thereof.

8. An adhesive anti-slip pad, the adhesive anti-slip pad comprising:
a sheet of material comprising:
a first side having a first surface comprising a textured rubber polymer surface; and
a second side having a second surface comprising an adhesive, and
wherein the sheet of material is die cut into an adhesive anti-slip pad in a predetermined shape, and
wherein the textured rubber polymer surface provides a gripping or a non-slip effect when in contact with a surface of an object.

9. The adhesive anti-slip pad of claim 8, wherein the predetermined shape of the adhesive anti-slip pad is configured for placement of the adhesive anti-slip pad on a finger or thumb of a wearer, approximate to a distal phalanx portion of the finger or thumb.

10. The adhesive anti-slip pad of claim 8, wherein the predetermined shape of the adhesive anti-slip pad is configured for placement of the adhesive anti-slip pad on a finger of a wearer, approximate to an intermediate phalanx of the finger.

11. The adhesive anti-slip pad of claim 8, wherein the predetermined shape of the adhesive anti-slip pad is configured for placement of the adhesive anti-slip pad on a palm of a wearer, approximate to a thenar portion of the palm.

12. The adhesive anti-slip pad of claim 8, wherein the predetermined shape of the adhesive anti-slip pad is configured for placement of the adhesive anti-slip pad on a palm of a wearer, approximate to a thenar eminence portion of the palm.

13. The adhesive anti-slip pad of claim 8, wherein the predetermined shape of the adhesive anti-slip pad is configured for placement of the adhesive anti-slip pad on a top portion of a thumbstick of a video game controller.

14. The adhesive anti-slip pad of claim 8, wherein the predetermined shape of the adhesive anti-slip pad is configured for placement of the adhesive anti-slip pad on a top portion of a button of a video game controller.

15. An adhesive anti-slip pad comprising:
a first side having a first surface comprising a textured surface;
a second side having a second surface comprising an adhesive, and
wherein the adhesive anti-slip pad is configured for placement on a thumb, a finger, or a palm of a wearer, and
wherein the adhesive anti-slip pad comprises a thickness so that if the adhesive anti-slip pad comes in contact with a surface of another object after placement of the adhesive anti-slip pad on the thumb, finger, or palm, the wearer receives a tactile response.

16. The adhesive anti-slip pad of claim 15, wherein the thickness of adhesive on second surface is about 10 μm to about 50 μm.

17. The adhesive anti-slip pad of claim 15, wherein the thickness of textured surface is about 0.1 mm to about 1.5 mm.

18. The adhesive anti-slip pad of claim 15, wherein the textured surface provides a gripping or non-slip effect between the adhesive anti-slip pad and another object.

19. The adhesive anti-slip pad of claim 15, wherein the adhesive covers at least 50% of the second surface.

20. The adhesive anti-slip pad of claim 15, further comprising a release film releasably attached to the adhesive, wherein the release film protects the adhesive.
